(19) United States
(12) Patent Application Publication
(10) Pub. No.: US 2009/0228405 A1
(43) Pub. Date: Sep. 10, 2009

(54) Apparatus and Method for Determining and Applying an Energy Savings to a Financial Transaction

(76) Inventors: Teresa Lopez, Santa Fe, NM (US); James A. Baker, Santa Fe, NM (US)

Correspondence Address: Kunzler & McKenzie, 8 EAST BROADWAY, SUITE 600, SALT LAKE CITY, UT, 84111, US

(21) Appl. No.: 12/347,741

(22) Filed: Dec. 31, 2008

Related U.S. Application Data
(60) Provisional application No. 61/034,898, filed on Mar. 7, 2008.

(51) Int. Cl. G06Q 90/00

(52) U.S. Cl. 705/412

(57) ABSTRACT

An apparatus, system, and method for determining and applying an energy savings to a financial transaction includes estimating and/or monitoring usage of utilities by detectors, comparing the usage to a predetermined baseline value, and valuating an energy savings. A portion of the savings may be applied to any of early repayment of a mortgage loan, investment in securities, and a request for a credit. The method enables issuance of mortgage loans for building projects that conserve or produce energy, where the loans may have terms that are similar or better than conventional mortgage loans. The method standardizes values of energy units and/or monetary units, and quantifies a savings. Thus, the method aids in qualifying the building project based on a particular amount of energy savings or a savings within a range. Thus, the method forms a bridge between green, other energy conserving, or sustainable technologies and the financial markets.

### CROSS-REFERENCES TO RELATED APPLICATIONS

This application is a continuation-in-part of and claims priority to U.S. Provisional Patent Application No. 61/034,898 entitled “APPARATUS, SYSTEM, AND METHOD FOR DETERMINING AND APPLYING A UTILITY SAVINGS TO A FINANCIAL TRANSACTION” and filed on Mar. 7, 2008 for Teresa Lopez, which is incorporated herein by reference.

### BACKGROUND OF THE INVENTION

1. Field of the Invention

This invention relates to utility savings in building construction and more particularly relates to ways of using the savings.

2. Description of the Related Art

Builders who are concerned about the environment or who wish to save money have undertaken building projects designed to reduce the use of utilities, and in particular to reduce the consumption of nonrenewable energy. Generally, the benefits of such construction are well known.

Many building projects include improved or increased insulation. Others incorporate photovoltaic cells or wind generators. Technologically, consistently building energy-efficient or energy producing homes and offices is achievable. However, higher initial costs for such construction often dissuade builders and buyers from building more energy-efficient buildings. Typically, the buyer must bear the burden of the higher initial costs due to lack of financial incentives and a lack of financing programs that cover energy efficiency or energy producing enhancements. Furthermore, it is often unclear how much benefit such enhancements will provide, and how long it will take to recoup the extra initial cost. Thus, the higher initial costs and uncertainty regarding payback have presented significant barriers to more universal implementation of energy-efficient and energy producing systems in building projects.

### SUMMARY OF THE INVENTION

From the foregoing discussion, it should be apparent that a need exists for an apparatus, system, and method that offset higher initial costs by assurances of a payback with more definite terms. Beneficially, such an apparatus, system, and method would help to quantify or provide a valuation of a utility savings that is realized through incorporation of energy-efficient or energy producing systems. Another advantage made possible by such an apparatus, system, and method is the automatic application of a clearly quantified utility savings to one or more financial transactions that have a monetary value corresponding to the quantified savings.

The present invention has been developed in response to the present state of the art, and in particular, in response to the problems and needs in the art that have not yet been fully solved by currently available incentive programs, financing programs, and investment programs. Accordingly, the present invention has been developed to provide an apparatus, system, and method for determining energy savings and/or incentive credit(s) and applying those savings and/or credit(s) to a financial transaction in ways that are outside the realm of conventional incentive, financing, and investment programs. The apparatus, system, and method overcome some or all of the above-discussed shortcomings in the art.

Furthermore, an apparatus, system, and method for determining and applying a utility savings and/or incentive credit(s) to a financial transaction may include applying a portion of the utility savings and/or credit(s) to at least one of early repayment of a mortgage loan and investment in securities. The method may further include a request for the credit, and/or applying the credit to a financial transaction. The apparatus, system, and method enable issuance of mortgage loans for building projects that conserve or produce energy, where the mortgage loans have terms that are similar or better than conventional mortgage loans. The method standardizes energy units to a common unit and then converts the savings values of one or more utilities into a monetary value. The method also quantifies a savings of the utilities. Thus, the method helps to qualify the building project based on a particular amount or range of energy savings, for example. Thus, the apparatus, system and method form a bridge or nexus platform between green or energy sustainable technologies and the financial markets.

In one embodiment, the apparatus for determining an energy savings and applying at least a portion of the savings to a financial transaction is provided with a plurality of modules configured to functionally execute the steps of metering usage of energy, analyzing an energy savings, and applying at least a portion of the savings to a financial transaction. These modules in the described embodiments include a metering module configured to receive signals representing usage of one or more of energy, temperature, flow, current, volume, and mass of at least one utility. The modules also include an analysis module configured to predetermine a baseline value and compare usage of the at least one utility to the predetermined value and determine an energy savings. The modules also include an execution module configured to apply at least a portion of the savings to a financial transaction.

In one embodiment, the apparatus further includes an incentives module configured to convert at least a portion of the savings into at least one of a carbon credit, net credit, utility company incentive, and government incentive. In one embodiment, the apparatus includes at least one of the modules configured to convert a plurality of units of usage for the plurality of utilities into a single common energy unit. Alternatively or additionally, at least one of the modules is configured to convert at least one of the units of usage and/or energy unit into a single unit of currency. In one embodiment, the analysis module includes a calculation module and the analysis module at least in part forms a nexus platform between a sustainable building industry and a financial industry.

In one embodiment, the execution module includes a bundling module configured to selectively combine a plurality of financial incentives into a package. In this embodiment, the execution module selectively applies the package to at least one of a retrofit construction or new building construction that involves at least one of sustainable features and green features.

In one embodiment, the analysis module includes a modeling module configured to model financial risk to facilitate capital funding for at least one of a retrofit construction and a new build construction that includes at least one of sustainable features and green features.

In one embodiment, the apparatus includes a tax incentive module configured to identify and apply at least one tax incentive for at least one of a retrofit construction and a new build construction having at least one of sustainable features and green features.

In one embodiment, the apparatus includes an energy usage factors module configured to receive input regarding at least one energy usage factor category from the categories consisting of a building shell, climate zone, HVAC, renewable energy, appliance, building occupancy, and utilities. The energy usage factors module may include a user interface configured to prompt a user for input into a plurality of the usage factor categories.

In one embodiment, the apparatus includes an energy efficient appraisal calculation module configured to add a value of energy savings to an appraised building value.

In another embodiment, a system or apparatus may include a mortgagor module and a mortgagee module. The mortgagor module may include at least a portion of the analysis module and the execution module. The mortgagor module may be configured for at least one of setting terms of the loan and applying at least a portion of the savings to repayment of the loan. The mortgagee module may include at least a portion of at least one of the metering module and the analysis module. The mortgagee module may be configured for at least one of the collecting and transmitting usage data to the mortgagor and informing the mortgagee of the savings and the portion thereof applied to the repayment of the loan. The system and/or apparatus may further include one or more detectors operably associated with at least one utility. The one or more detectors may be operably connected to at least one of the mortgagor module and the mortgagee module.

In one embodiment, at least one of the mortgagor module and the mortgagee module is integrated in a single application together with at least one of an energy usage factors module and an energy efficient appraisal calculation module. The single application may also include a user interface for at least one of inputting data representing energy usage factors and calculating an energy efficient appraisal. Additional modules may also be included in the single integrated application, without limitation.

An embodiment of the invention includes a method for determining at least one of an energy savings and an incentive, and applying the energy savings and/or incentive to a financial transaction. The method in the disclosed embodiments substantially includes steps for carrying out the functions presented above with respect to the operation of the described apparatus and system. These steps may include automatically detecting or determining at least one of an incentive and an energy savings, and automatically applying at least a portion of the at least one of the incentive and the energy savings to a financial transaction. In one embodiment, the method includes detecting or determining usages of a plurality of utilities.

In one embodiment, determining includes receiving input through a user interface regarding at least one of a plurality of energy usage factors. In this embodiment, receiving input may include receiving input under control of machine readable code physically embodied in storage media in a digital processing device.

In one embodiment, the method includes automatically charging a fee to at least one of a financial market and a real estate market for use of the method.

In one embodiment, the method further includes automatically determining at least one of an appropriate green feature or a sustainable feature for at least one of a retrofit construction and a new build construction.

In one embodiment, determining includes selecting a particular regional climate and analyzing a cost and an energy savings for the particular regional climate.

In one embodiment, the method includes absorbing an infrastructure cost by applying the savings to the infrastructure cost.

In one embodiment, determining and applying include accelerating a mortgage loan repayment. The loan repayment is accelerated by determining at least one of a utility savings and an incentive and applying at least a portion of the at least one of the savings and the incentive to the mortgage loan repayment. In this, as in other embodiments, determining and applying may be implemented automatically according to instructions in machine-readable code.

In a further embodiment, the method includes automatically detecting or determining, automatically analyzing, and automatically applying under control of machine-readable code physically embodied in storage media in a digital processing device.

In still another embodiment of the present invention, an article of manufacture includes a computer program storage medium readable by a processor and embodying one or more instructions executable by a processor to perform a method for determining an energy savings and applying at least a portion of the savings to a financial transaction. The method includes determining at least one of an energy savings and a credit incentive according to the instructions and applying at least a portion of at least one of the energy savings and the credit incentive to a financial transaction.

In one embodiment, the method includes detecting a usage of at least one utility by at least one sensor and receiving a signal representing the usage in a processor from the sensor.

In one embodiment, applying at least a portion of the savings to a financial transaction includes applying the portion of the savings automatically according to the machine-readable instructions under control of the processor. In another embodiment, applying at least a portion of the at least one of the energy savings and the credit incentive to the financial transaction includes applying the portion to repayment of a loan. Applying the portion to repayment of the loan may include calculating at least one incentive from among renewable energy credits and carbon credits, and bundling the at least one incentive with at least one energy savings. One embodiment includes offsetting at least one of an interest rate, a closing cost, and a loan balance based on at least one of the incentive and the energy savings. In one embodiment, the step of applying embodied in the article of manufacture includes applying the portion to investment in a securities exchange commodity.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. The invention may be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above is set forth by reference to specific example embodiments that are illustrated in the appended drawings. These drawings depict only typical embodiments of the invention and are not to be considered limiting of the scope. Thus, embodiments of the invention will be described and explained with additional specificity and detail through the use of the accompanying drawings, in which:

FIG. 1 is a block diagram of a system and apparatus for determining a savings in a utility and applying at least a portion of the savings to a financial transaction in accordance with embodiments of the present invention;

FIG. 2 is a another block diagram of a system and apparatus for determining a savings of utilities and applying at least a portion of the savings to a financial transaction corresponding to a portion of the block diagram of FIG. 1 in accordance with embodiments of the present invention;

FIG. 3 is a block diagram illustrating a method for determining a savings and applying the savings to a financial transaction in accordance with embodiments of the present invention;

FIG. 4 is a diagrammatic representation of the extensive usefulness of a system for determining a savings in a utility and applying at least a portion of the savings to a financial transaction in accordance with embodiments of the present invention;

FIG. 5 is a block diagram showing specifics of one aspect of the system and apparatus for determining a savings in a utility and applying at least a portion of the savings to a financial transaction in accordance with embodiments of the present invention;

FIG. 6 is a schematic block diagram illustrating specifics of the system and apparatus for determining a savings in a utility and applying at least a portion of the savings to a financial transaction in accordance with embodiments of the present invention;

FIG. 7 is a block diagram representing a method of marketing with the system and methods of the present invention;

FIG. 8 is a flow diagram showing an embodiment of the method, including examples of interacting entities and possible sequences of steps in a new construction or retrofit construction loan process; and

FIG. 9 is an example diagrammatic view depicting a user interface presenting the new construction/retrofit construction loan process with selectable options.

### DETAILED DESCRIPTION OF THE INVENTION

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. However, the invention may be practiced without one or more of the specific details, or with other methods, components, materials, and so forth. In other instances, well-known structures, materials, or operations are not shown or described in detail to avoid obscuring aspects of the invention.

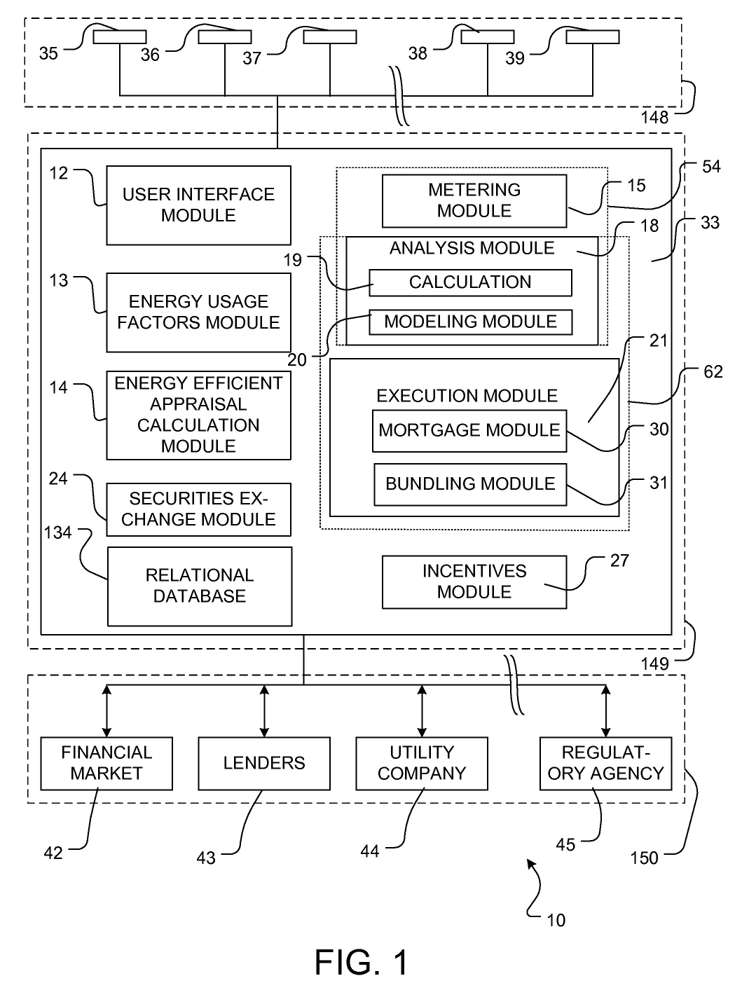

FIG. 1 is a block diagram of a system 10 for determining a savings and applying the savings to a financial transaction in accordance with embodiments of the present invention. The system 10 may include machine-readable code such as software having one or more modules associated with a variety of functions. For example, the code may include a user interface module 12, energy usage factors module 13, energy efficient appraisal calculation module 14, metering module 15, analysis module 18 optionally including calculation and modeling modules 19, 20, and execution module 21. Additional modules may include a securities exchange module 24 and an incentives module 27. Each of the modules may further have submodules. For example, the execution module 21 may include a mortgage module 30. The incentives module may be, or may include, a tax incentive(s) module. The machine-readable code may be stored in memory and incorporated into a computer 33 such as a Web server or other electronic device that includes a processor. It is to be understood that the several modules and components may be in a single electronic device or may be incorporated into a plurality of devices or computers that are interconnected to provide the intended function of the system 10.

The system 10 may further include a plurality of detectors 35, 36, 37, 38, 39 that are configured to be associated with a plurality of utilities. For example, detector 35 may be a meter that detects a flow of natural gas to a residential or commercial building and transmits a signal representing the flow of gas to the computer 33 or other electronic device. Detector 36 may be a sensor that detects electrical power usage in the residential or commercial building. Detector 37 may include a meter for determining a flow of water to the building and sending a signal representing the flow to the computer 33. Detector 38 may include a sensor or other metering device indicating a flow, mass, or volume of sewage generated by the building. Detector 39 may be a sensor that detects and signals a quantity of trash in terms of mass or volume. Other detectors may be incorporated without limitation. For example, detectors that measure one or more of electrical current, electrical voltage, and temperature may be utilized. The temperature sensors may be utilized to obtain data for determining a threshold or baseline value with which current energy usage values are compared.

The computer 33 or other electronic device may be operably connected to one or more of a plurality of entities that are either interested in the data collected by the computer 33, or from which entities the computer 33 is capable of receiving data. For example, the computer 33 may be connected to one or more entities in financial markets 42, lenders (such as mortgage companies or banks) 43, utility companies 44, and regulatory agencies 45.

The metering module 15 of the machine-readable code is configured to receive signals from the detectors 35, 36, 37, 38, 39 and quantify the actual usage of the various utilities that is being detected. Alternatively, the actual usage of the various utilities may be determined all or in part by obtaining the usage from another source such as a utility company. The system and apparatuses of embodiments of the present invention are capable of utilizing usage data from other sources or signals representing usage from sensors provided independently of the system and apparatuses of the present invention. The analysis module 18 utilizes historic data and/or engineering modeling data to determine a baseline of usage for each of the utilities. This is achieved by execution of baseline formulas that have been developed to accurately represent the energy usage.

In a simple example, the current temperature and historic weather patterns may be used to calculate a baseline value of energy usage. Then the analysis module 18 determines the actual utility savings by comparing the actual usage to the baseline values. This may be accomplished by simply taking the difference between the actual usage and the baseline values. Other more complex analyses may be undertaken to take into account additional factors. For example, in most cases, the cost of the improvements should be subtracted from the energy savings. The savings minus costs can then be amortized over the life of the improvements at the current interest rate to take into account the time value of the money saved. Alternatively, the lender can re-amortize the loan after taking into account the saving (minus the costs) that will be applied to early repayment. In one embodiment, specific formulas are developed for calculating the energy efficiency on all utilities. In any case, the metering module 15 and the analysis module 18 quantify the usage and the savings, and make these values available in a form that is understandable and useful to one or more users including the various interested entities 42, 43, 44, 45 through a user interface module 12. In this regard, the machine-readable code of embodiments of the present invention is configured to interact with conventional computer programs and machine-readable code in computers utilized by these various interested entities. Thus, the information derived from the formulas and through the analysis is translated into a form usable by the financial and real estate markets.

In one embodiment, the analysis module utilizes any of a variety of mathematical formulas to calculate the baseline value and the savings. The mathematical formulas may incorporate numerous variables that are supplied from among data that includes one or more of geographical regions, weather patterns, temperatures, and building usage times and patterns. The building usage patterns may include occupancy times, heating and cooling requirements, etc. Theoretically, the more variables that are used in this calculation, the more accurate will be the resulting quantification. On the other hand, it is to be understood that some variables will be less significant or negligible relative to others.

The execution module 21 utilizes the data, including data from the analysis module, and any user input to apply at least a portion of the savings to one or more financial transactions. For the purposes of this disclosure financial transactions include one or more of quantification and/or valuation of savings into dollars or other known monetary units, prepayment of a loan, purchase of a commodity, request for an incentive credit, and initiation of application for a tax credit. In the embodiments shown in FIG. 1, the execution module 21 includes a mortgage module 30 for controlling early repayment of a mortgage loan based on the utility savings. It is to be understood that the mortgage module 30 could be separate from the execution module 21 and still function together with the execution module 21 to implement repayment of the mortgage loan. Although shown separately, the securities exchange module 24, the incentives module 27, and/or other modules could be incorporated into the execution module 21.

In particular, the machine-readable code on computer 33 or other electronic device may be configured to interface with mortgage companies or other lenders for the purpose of transmitting data representing energy savings or other utility savings so that the mortgage companies can apply at least a portion of the savings to early repayment of mortgagee's loans. The machine-readable code may also be configured to automatically and regularly remit a predetermined portion of the savings as an early repayment of the loan.

The machine-readable code is configured to interact with a utility company 44, for example, to receive historic and/or current data on a usage of a utility. The historic data can be used by the analysis module 18 to compare the historic data to the current usage data and to determine the utility savings. Alternatively or additionally, the machine-readable code may be configured to supply data to the utility company 44 for comparison with their records of usage and/or for sending data indicating a quantity of energy put back into the grid by the building when the building is an energy producing structure.

The machine-readable code may include the securities exchange module 24 that is configured to interact with companies in the financial market 42 for the purpose of purchasing securities or for selling carbon credits, for example. Thus, data representing the purchase or sale values of at least a portion of the utility savings may be transmitted by the securities exchange module 24 to the financial market 42. Similarly, data representing market values of the securities or carbon credits may be transmitted from the financial market to the computer 33 or other electronic device.

The machine-readable code may also be configured to interact with one or more regulatory agencies for the purpose of receiving data or other information regarding interest rates, tax incentives, or carbon credits, for example.

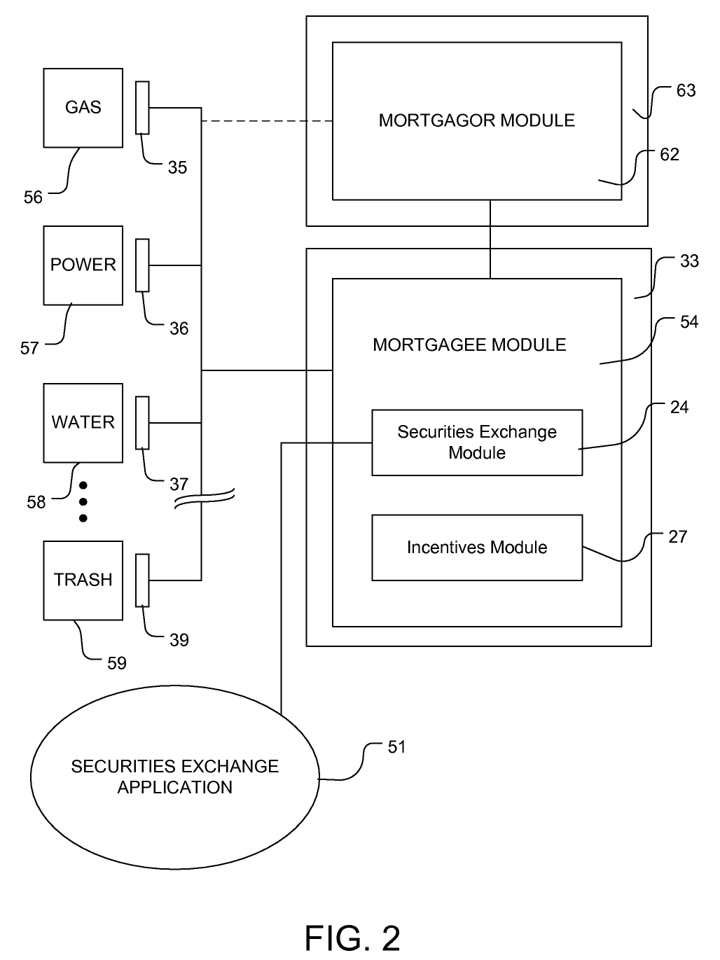

As shown in the specifics of FIG. 2, the apparatus for determining a savings of a utility and applying at least a portion of the savings to a financial transaction may further include the securities exchange or trading module 24 that is configured to interface with the execution module 21 (shown in FIG. 1) and a securities exchange application 51 that may be available in the financial market 42 for automatically applying at least a portion of the savings to investment in a securities exchange market. Alternatively, the securities exchange application 51 may be integrated as a non-remote module in the apparatus, and may receive regular or frequent updates to data from the financial market.

FIG. 2 also shows the securities exchange module 24 and the incentives module 27 forming part of a mortgagee module 54. It is to be understood that the mortgagee module 54 may include all of the modules and submodules shown in FIG. 1. Alternatively, the mortgagee module 54 may include at least a portion of at least one of the analysis module 18 and the metering module 15, as indicated by the dashed line labeled 54 in FIG. 1. The mortgagee module 54 may be supported on a computer 33 or other electronic device located at the mortgagee's building, for example. Thus, the detectors 35, 36, 37, 39 may be directly associated with respective utilities such as gas 56, power 57, water 58, and trash 59, for example. That is, sensors, meters, and/or other detectors may be placed on gas, power, and water lines or meters as needed. The detectors 35, 36, 37, and 39 are operatively connected to the computer 33 or other electronic device in order to transmit signals representing usage of the various utilities. It is to be understood that the connection between the computer 33 or other electronic device and the detectors or other devices may be wired or wireless connections.

While the machine-readable code providing the various modules shown in FIG. 1 may be configured to interface with conventional computer programs and code utilized by interested entities 42, 43, 44, and 45, these interested entities may alternatively have respective modules loaded on their computers for interfacing with the various modules shown in FIG. 1. Thus, FIG. 2 shows a mortgagor module 62, which may be supported on a computer 63 located at one of the lenders corresponding to lenders 43 in FIG. 1. It is not required that the modules shown in FIGS. 1 and 2 be located at the user's or mortgagee's building. In fact, in one embodiment, all the modules shown in FIG. 1 may be incorporated into the mortgagor module 62 of FIG. 2. In this case, the mortgagee module 54 would not need the securities exchange module 24 and the incentives module 27 because they would be included in the mortgagor module 62. Signals representing the utilities usage could be transmitted by a wired or wireless connection from the user or mortgagee's building to the mortgagor module 62 at the mortgage company. While the mortgage company has a direct interest in applying the utility savings to early payment of a mortgage loan, the machine-readable code and modules on the computer 63 at the mortgage company could still implement investment in securities and initiation of incentive credit and/or tax credit requests for the mortgagee. Alternatively, these credits could be received by the mortgagor or developer in exchange for improved loan terms to the mortgagee.

In an alternative embodiment, a dashed line in FIG. 1 shows the mortgagor module 62 including at least a portion of at least one of the analysis module 18 and the execution module 21.

It is to be understood that the number and type of utilities monitored and the utility savings to be quantified in accordance with the embodiments of the present invention is unlimited. While FIGS. 1 and 2 show gas, power, water, sewer, and trash, other utilities may be monitored for savings as well. For example, other fuels such as heating oil, coal, alcohol, diesel fuel, etc. may be additionally or alternatively monitored. Still, the metering and analysis modules determine usages of the plurality of utilities and compare the usages with predetermined baseline values of the respective utilities.

While the various modules have been described as providing a system and apparatus for determining a savings in a utility and applying at least a portion of the savings to a financial transaction, it is to be understood that such a system and apparatus may include as few as one of the modules described, or may include more than the number of modules shown and described. In any case, the system an apparatuses described herein may be used to implement embodiments of the method of the present invention described below.

The schematic flow diagrams that follow are generally set forth as logical flow diagrams. As such, the depicted order and labeled steps are indicative of embodiments of the presented method shown in respective Figures. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

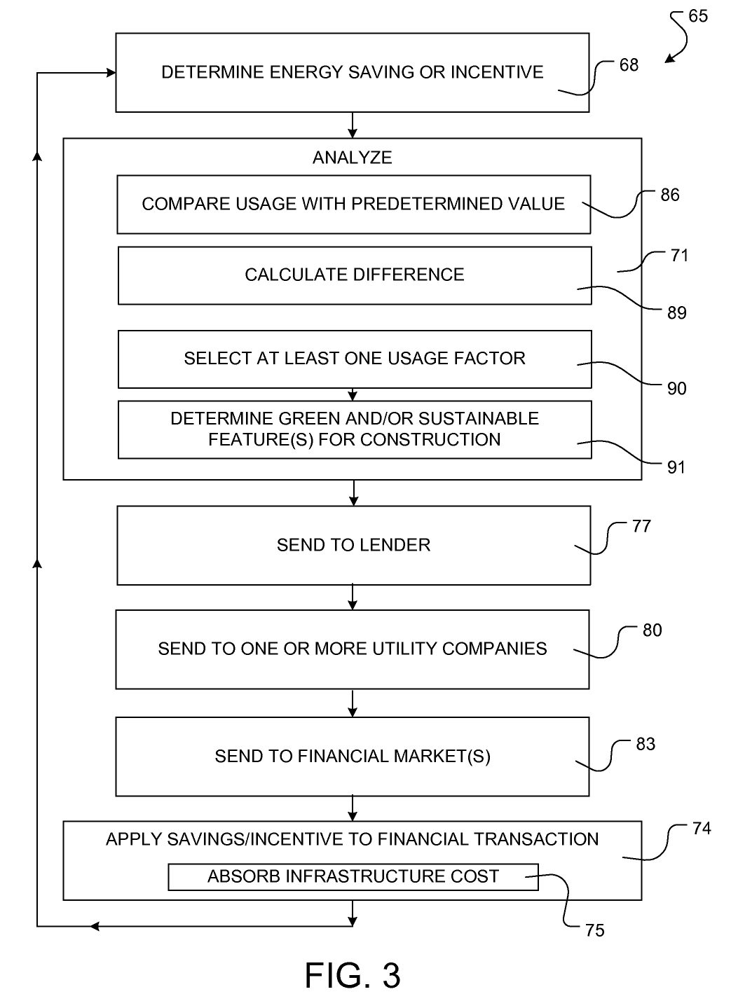

FIG. 3 is a block diagram illustrating embodiments of a method 65 for determining a utility savings and applying the savings to a financial transaction. In one embodiment the method includes determining an energy saving or an incentive 68, analyzing a savings associated with the usage 71, and applying at least a portion of the savings to a financial transaction 74. In a specific case, determining the energy savings includes detecting a usage of a least one utility. Also in a specific case, the savings is applied in a way that absorbs infrastructure costs 75. Additional embodiments include sending data to a lender such as a mortgage company 77, sending data to one or more utility companies 80, and sending data to one or more entities in the financial markets 83. As may be appreciated, embodiments of the method may include receiving data from one or more of the lender, utility companies, and entities in the financial markets. Applying at least a portion of the savings to a financial transaction may simply consist of valuating a savings in a utility usage. On the other hand, applying at least a portion of the savings may include one or more of making an early payment on the principle of a loan, obtaining credits for energy or other utilities conserved or produced, and investing in the financial markets.

In one embodiment, the step of determining or detecting usage 68 includes detecting usages of the plurality of utilities. As may be appreciated, depending on the utility being detected, detecting may include sensing at least one of mass, volume, flow, current, energy, and temperature. Signals representing usage of the one or more utilities are received and analyzed. This may be done in real-time resulting in quantification of real-time energy usage. The step of analyzing may further include comparing the usage with a predetermined value 86, and calculating a difference between the actual usage and the predetermined value 89. The predetermined value may be a baseline, as discussed in other parts of this disclosure. Thus, applying at least a portion of the savings 74 may include applying at least a portion of the difference between the actual usage and the predetermined value to the financial transaction. Alternatively or additionally, the step of analyzing 71 may include selecting at least one usage factor 90. For example, the method may include selecting a climate or climate region and accessing data associated with that climate. By accessing temperatures and wind speeds, for example, the step of analyzing can calculate a base line usage of energy to which an actual usage can be compared, and/or the step of analyzing can calculate a predicted usage of energy with one or more green and/or sustainable features incorporated into a building. Likewise, analyzing 71 may include determining a green or sustainable feature for construction 91.

One of the benefits of the embodiments of the method in accordance with the present invention is that the steps of detecting, analyzing, and applying may be achieved automatically under the control of instructions embodied in machine-readable code that may be stored in storage media or memory of a computer, or that may be supported on an electronic device. Similarly, the steps of sending and/or receiving from lenders, utility companies, and entities in the financial markets may also be automated. Thus, all or part of the utility savings may be automatically applied to one or more of early payment on a loan principal, request for credit, and investment in the financial markets.

Embodiments include methods of doing business, which may include one or more software programs that enable the business methods. One of the advantages of the methods and the related technology that is incorporated into associated apparatuses and systems is that they facilitate a quantification of energy savings in building construction. In one embodiment, the quantification of the savings allows mortgages to be issued based on the amount of savings anticipated and to then directly tie mortgage payments to the actual savings. This embodiment of the method enables approval of loans having better terms for the borrower and/or facilitates accelerated loan payoff. Embodiments of the invention also facilitate securities trading based on one or more of anticipated savings, actual savings, carbon credits, and net savings. Other embodiments may include a combination of the mortgage program and securities trading in which sale of carbon credits or other investments may be tracked by the software.

For the purposes of this disclosure, net savings means incentives paid by electric and other public utility companies for energy or other utility benefits produced at a business or residence that is/are returned into the grid system. These, like the other savings, can be applied to repayment of a mortgage loan. Other types of incentives paid by these utility companies or the government could also be applied in embodiments of the method. These incentives may include credit incentives, rebates, and/or tax deductions for switching to more energy efficient furnaces, increasing insulation, building green, etc.

Software may be applied at the residence or commercial building that is being upgraded or built with energy efficient or energy producing features. The software may be run on a computer at the residence or commercial building. Alternatively or additionally, other digital processing devices may be utilized. For example, a microprocessor or programmable logic controller (PLC) may be configured to carry out one or more of the steps of detecting, analyzing, and applying. The microprocessor may also be configured to send and/or receive signals to and from one or more of lenders, utility companies, and financial markets. Signals may be sent and received through wired or wireless network(s). Sensors may be placed on the electricity meter and other locations for monitoring power, gas, and other utilities to determine the amount and cost of the utilities being used.

In one embodiment of the method, a computer or other digital processing device collects the data and uploads it to a server running at a mortgage company facility. Software and/or some other digital processing mechanism at the mortgage company calculates the amount of energy expended, the cost of that energy, and the actual saving as compared to a baseline value during a predetermined period of time. The amount of savings is then applied to the mortgagee's loan principle, accelerating the loan repayment. The money can either be directly withdrawn from the banking account of the mortgagee, or applied in some other manner. It is to be understood that similar embodiments could be applied through software and/or other digital processing devices located at the residence or commercial building for which the loan has been issued, or at a completely separate location. Whether performed electronically or otherwise, the idea is that at least a portion of the savings can be applied to repayment of the loan principle to accelerate repayment.

In one embodiment, the method includes drawing up a mortgage that provides favorable terms based on the anticipated energy savings. In another embodiment, the method includes contractually binding the mortgagee and the mortgage company to accelerate repayment of the mortgage based on the amount of actual savings. That is, the contract would give the mortgage company the right to automatically apply at least a portion of the savings to early payment on the principle of the mortgage loan. The amount of the savings to be applied may be a predetermined maximum or a percentage of the savings, and may be written into the contract. Software and/or other digital processing devices may be installed at the mortgagee location and/or the mortgagor's facility. The sensors or other detectors may be installed on one or more of the electric meter and various other locations. The software may also tie into one or more of carbon credit trading locations, net savings locations such as utility companies, and other incentive savings locations such as governmental agencies. The software and/or other digital processing devices then collect data regarding energy and/or other utility usage over the course of the month, for example. Incentives for which the savings qualify the mortgagee and/or mortgagor may be tabulated and uploaded to the mortgage company. The mortgage company calculates the savings, applies the savings to accelerate the mortgage payment and sends a bill reflecting the early payment to the mortgagee, or the mortgage company otherwise receives payment on the accelerated basis. It is to be understood that the same detecting, quantifying, and applying of usage and savings may be managed by one or more entity other than the mortgage company without limitation.

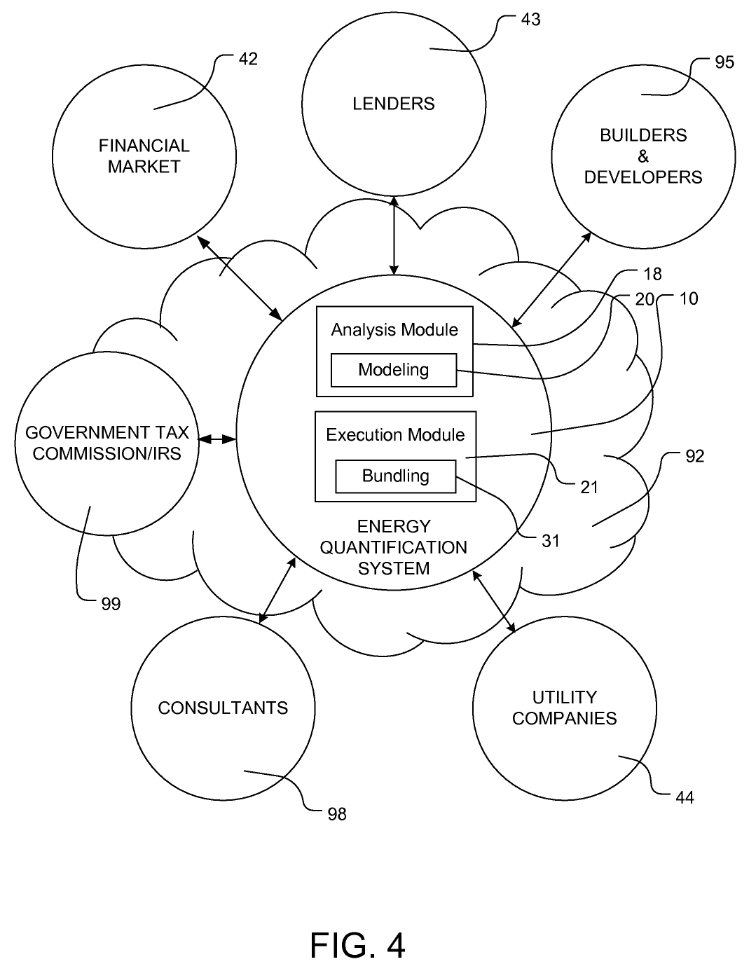

FIG. 4 is a diagrammatic view illustrating how the energy quantification system 10, in accordance with embodiments of the present invention, may be interconnected with a variety of entities that are interested in participating in the programs and methods associated with the system. Indeed, the system 10 and methods may be made available universally to any and all interested entities. For example, data and instructions may be communicated over a network 92 such as the Internet and/or a telephone network. The network 92 may include wired and wireless connections. As shown in FIG. 4, whether the energy quantification system 10 is located at a location of the mortgagee, mortgagor, some other location, or at a combination of locations, the system 10 can be operably connected over the network 92 to a variety of interested entities including entities in the financial markets 42, lenders 43, and utility companies 44. Other interested entities may include builders and developers 95, consultants 98, and government agencies 99 such as tax commissions and/or the Internal Revenue Service (IRS). As described above, the energy quantification system 10 includes an analysis module 18 for calculating energy savings, and an execution module for applying the savings to a financial transaction. The Analysis module 18 may include a modeling module 20 and the execution module 21 may include a bundling module 31 for modeling the savings/incentives to users and bundling savings/incentive in attractive and concrete ways. The payback mechanisms are clear and viable for the financial market 42 and the lenders 43. Thus, the energy quantification system 10 forms a bridge or nexus platform between the builders and developers 95 on one hand and the financial market 42 and the lenders 43 on the other hand with regard to green or sustainable construction projects. The systems and methods are presented with a high degree of visibility and transparency resulting in positive public relations for all types of users of the system 10 for continuing in or entering the emerging green/sustainable energy markets.

The system 10 and methods in accordance with embodiments of the present invention also bring together resources and benefits from the financial sector, well-established Internet based platforms and entities, renewable energy policy makers, and energy raters. In one embodiment, resources and benefits are made available together in a single site on an Internet Website. In exchange for the benefits of using these resources from a single place and the other advantages of the systems and methods describe herein, users may be required to pay fees. These fees may include one or more of membership fees, licensing fees, royalty fees, and product override fees/marketing fees for green/sustainable products. An example of a benefit that users will most likely be willingly to pay for through these fees is the creation of baselines for the green financial models. These baselines are needed by the financial and real estate markets for more universal entry into the green/sustainable building markets. Fees for using the energy quantification databases, which may include these baselines, may also be charged. Owners of Internet-based applications supporting the systems and methods may charge fees for the development and maintenance of the applications. These fees may be in addition to mortgage loan fees, and may be assessed to help cover business costs.

In one embodiment, the energy quantification system 10 includes machine-readable code supported on a server remote from the mortgagee and the mortgagor. In this embodiment, consultants 98 may use the energy quantification system to help builders and developers 95 to benefit from utility savings programs. In accordance with this embodiment, individuals or corporations wishing to conserve energy or to become energy producers in their building projects can access the needed information and become participants in the utility savings programs including programs that are set up to help mortgagees pay off their mortgages early. In this regard the system 10 may be supported on a platform that is universally available. For example, the platform may be a Web-based platform. Such a platform may be developed from scratch or the method may be implemented on existing platforms that are already well known and universally accessible. In any case, the system 10 and method 65 may be platform independent.

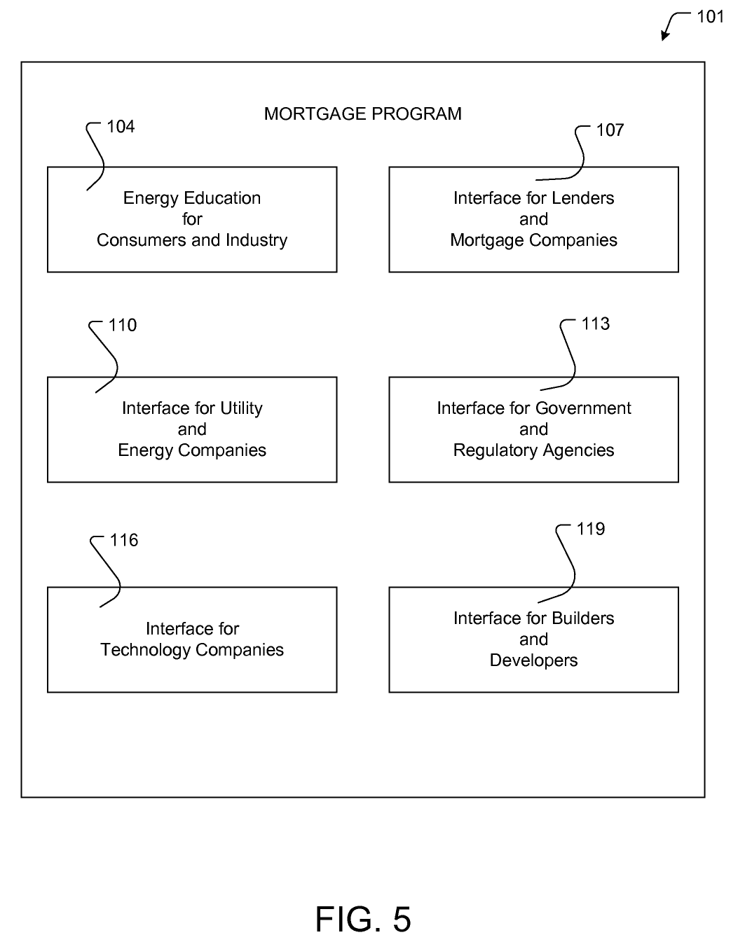

FIG. 5 is a diagrammatic view of an example of at least a portion of a program 101 that is available to interested entities. In this example, the program 101 is a mortgage program. Such a mortgage program may be embodied in a mortgage module 30 as shown in FIG. 1. As described above, the mortgage module 30 may be located at the mortgagor or the mortgagee, or may be located at a separate location such as on a server on the Internet. The mortgage program may include energy education for consumers and the industry 104. In addition to the public benefit of being an educational tool, the energy education and its presentation through the systems and methods described herein also facilitate marketing of green/sustainable technologies, including the systems and methods described herein. The mortgage program 101 may also include several interfaces that are provided by respective submodules for communication and/or data transfer to and from interested entities. These entities may include lenders and mortgage companies as indicated at 107, utility and energy companies as indicated at 110, and government and regulatory agencies as indicated at 113. Other interested entities may include technology companies, builders, and developers, as indicated at 116 and 119. The machine-readable code and/or other digital processing mechanisms that at least in part make up the mortgage program 101 may be configured to be compatible with conventional software that is typically used by the various interested entities. Additionally or alternatively, compatible software may be provided, such as by a download, to each interested entity. Thus, data can be transferred and transactions can be executed without difficulty.

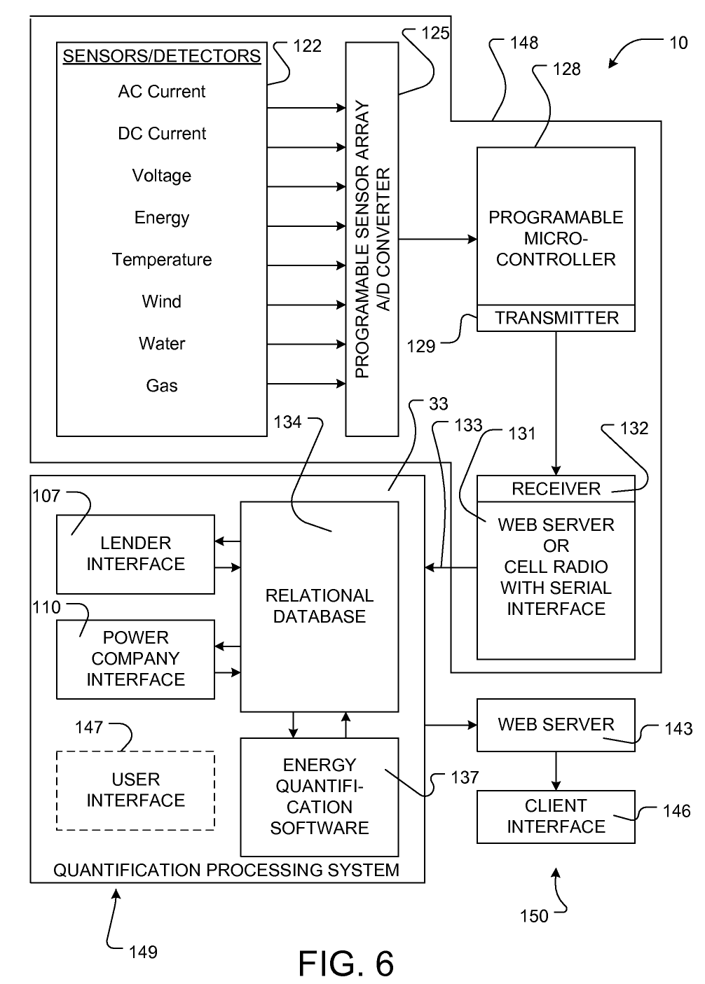

FIG. 6 shows another block diagram of the system 10 for determining a utility savings and applying at least a portion of the savings to a financial transaction similar to the block diagram of the system 10 shown in FIG. 1. However, FIG. 6 shows additional details. Each of the elements shown in FIG. 6 can be manufactured and supplied as a package or separately. Thus, the system 10 shown in FIG. 6, as well as in FIGS. 1 and 4, is an article of manufacture or a set of articles of manufacture. The articles of manufacture may include a set of sensors or detectors 122 and instructions regarding installation of the sensors or detectors 122. The sensors or detectors 122 may include a programmable sensor array. An analog/digital converter 125 may be associated with the sensors or detectors 122 in order to convert analog signals to digital signals usable by a digital processing device such as a programmable logic controller (PLC) or a programmable microcontroller 128. The programmable microcontroller 128 may include a transmitter that transmits signals from the various sensors or detectors 122 to a Web server or cell radio 131. The transmitter may be an RF transmitter, blue tooth, or cell phone based transmitter, for example. Alternatively, the microcontroller 128 may be wired to the Web server or a controller connected to the Internet. While a variety of sensors or detectors 122 are shown, it is to be understood that the system may include as few as one sensor/detector, or may include any number of sensors/detectors 122 greater than those listed in FIG. 6.

If the cell radio 131 is utilized to receive data from the programmable microcontroller 128, then another cell radio could be provided as a transmitter 129 together with the programmable microcontroller 128 and a serial interface to route the various signals from their respective sensors or detectors 122. In either case, the Web server or cell radio 131 has a receiver 132 for receiving the signals representing the utility usage. The Web server or cell radio also transmits the signals through a link 133 to a quantification processing system such as a computer 33 or other digital processing device that includes the various modules described with regard to FIG. 1 above. For example, the computer 33 may receive signals through the link 133 from the Web server or cell phone 131. The link 133 and the other links needed for communication between the various devices may include one or more of a modem, cellular network(s), satellite network(s), and the Internet. Thus, the signals can be received and/or processed for use in a metering module, analysis module, and execution module according to instructions in machine-readable code held in storage media in the computer 33.

The computer 33 may also have a relational database 134 stored therein, (also shown in FIG. 1). The relational database 134 may include historical data, data regarding weather patterns for various regions of a state, country or the world, data regarding building occupancy, and utility usage time data, for example. In one embodiment the analysis module uses this data to determine baseline values for utility usage for comparison with the actual utility usage represented by the signals received from the sensors or detectors 122. The metering module, analysis module, and execution module may be provided in the energy quantification software 137, which can send data to and receive data from the relational database 134. It is to be understood that the relational database 134 may be stored on one or more remote server(s) or other computer(s) on a network with which computer 33 may be connected. The relational database 134 may be integrated with other database(s) such as those that store usage data, for example.

The computer 33 can also have a lender interface 107 and a power or energy company interface 110 similar to the interfaces shown and described with regard to FIG. 5. The lender interface 107 and energy company interface 110 may form part of a mortgage program or module 101 in accordance with the embodiment shown in FIG. 5. In one embodiment, the mortgage module 101 may also include the energy quantification software 137. Alternatively, the energy quantification software 137 may include the lender and energy company interfaces as well as one or more of the modules shown in FIG. 1. Further alternatively, the system 10 may include the mortgage program 101 shown and described with regard to FIG. 5.

The computer 33 may be operatively connected to another Web server 143, which in turn is connected to a client interface 146. The client interface 146 may include a user interface module and any number of input/output devices. Thus, a user can pull up reports showing data, utility usage, and calculations including savings calculations on a screen, for example.

Alternatively or additionally, the computer 33 may include a user interface 147 that includes a user interface module and any number of input/output devices. Thus, a user can pull up reports showing data, calculations, and utility usage on a screen. Furthermore, the computer 33 and the overall quantification processing system may be located with a user such as a mortgage company. In this embodiment, the Web server or cell radio 131 and the Web server 143 maybe replaced by the computer 33 that also functions as a Web server to receive the signals from the sensors or detectors 122 and to deliver data and information to users and other interested entities. Such a computer 33 may take the form of a server anywhere on the network 92 shown in FIG. 4. In still another embodiment, the programmable microcontroller 128, the Web server or cell radio 131, the Web server 143, and the client interface 146, may be replaced by a single device or combination of devices located at the building of the mortgagee.

The system 10 shown in FIG. 6 may be generalized as including three main parts designated as the front end 148, the quantification processing system 149, and the back end 150 that includes one or more applications that interface with the quantification processing system 149. This generalization also applies to the other figures. For example, referring back to FIG. 1, the front end 148 has been designated by a dashed rectangle surrounding elements of the front end. The quantification processing system 149 and the back end 150 with its applications are likewise enclosed by respective dashed rectangles in FIG. 1.

One of the benefits provided by the system 10 is the automation of applying at least a portion of the savings to a financial transaction according to the instructions under control of a processor in the computer 33. In particular, the system 10 enables applying at least a portion of the savings to one or more of repayment of a loan, investment in a securities exchange commodity, and a request for credits. Another benefit provided by the system 10, is that a plurality of utilities may be monitored, and a plurality of signals from respective sensors or detectors may be received and processed by a single application to determine increased utility savings.

In one embodiment, the analysis module 18 of FIG. 1 or elements corresponding to the analysis module in embodiments of FIGS. 2-6 convert the utility savings into a common energy unit which may be uniquely created or may be a well known unit. For example, British Thermal Units (BTUs) may be converted to Kilowatt-hours. Based on the market value of energy, the energy savings can be converted to a monetary value.

In another embodiment, the system 10 provides a centralized application that processes data for many types of energy and utilities. The centralized application determines utility savings for all of the utilities being monitored, establishes a common energy unit, and quantifies the value of the savings in dollars of other monetary terms. This quantification makes the application of the present invention flexible for ease of interfacing with a wide variety of interested entities and their conventional applications.

In any case, the system 10 is a powerful tool that clearly quantifies energy savings in terms that are definite and readily understood by all interested parties. A mortgagee, for example, may use this tool to provide verification of energy savings or energy production data provided by the utility companies. In fact, the data may be sent back to the utility companies as indicated by arrows going to and from the power company 110 in FIG. 6, especially when the mortgagee is a net energy producer. Furthermore, the system 10 can be used to determine the efficiency of energy saving or energy producing systems that have not been previously tested. Because of the universal compatibility and the power of the system 10 as a universal tool, all or part of the system 10 may become an industry standard.

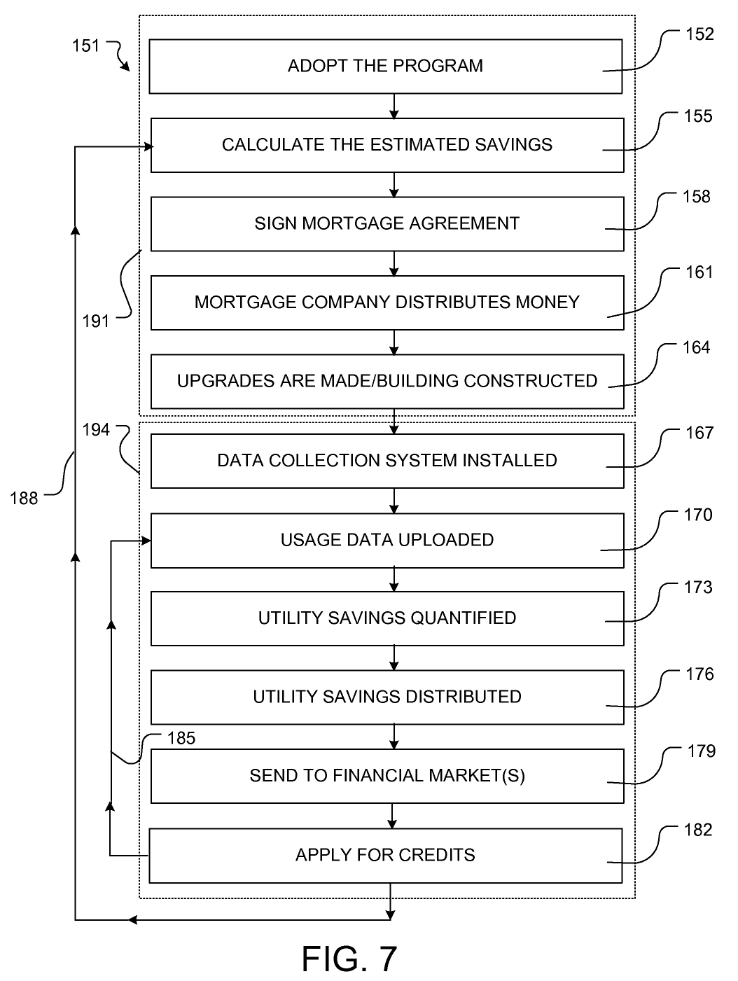

In another embodiment depicted in the flow diagram of FIG. 7, the system and method is usable by a mortgage or other company as a method of marketing 151, and may be licensed to multiple mortgage companies, for example. In this aspect of the method, a mortgage company adopts the program as indicated at 152. Among other reasons, adopting the program will facilitate a mortgage company's entry and/or further penetration into the green/sustainable building and utilities markets.

Because of trends in the housing and construction markets, it is likely that the green market will be increasingly important. This is true, at least in part, because interest rates are likely to go up, resulting in more refinancing. Green construction in the form of improved efficiency retrofits and remodels with energy production systems fits well with refinancing and second mortgage financing. Remodeling with more efficient or energy producing features also adds to the capital value of the subject buildings. Therefore, the risk of making the loan is reduced. Furthermore, energy and money are conserved. Due to the clarity and assurances provided by the quantification made possible by the embodiments of the present invention, green upgrades will increasingly become good candidates for financing. Green upgrades will provide the additional opportunity to gain back the expended money as well as increase the value of the buildings. Furthermore, laws are being enacted to raise the bar and require certain minimal standards of energy conservation and to reward some specific energy saving and energy producing construction. Therefore, individuals and companies will tend away from the typical deferred maintenance and will upgrade their buildings with green or sustainable improvements. Many of the benefits and reasons for remodeling also apply to new building projects, and individuals and companies will choose to build green new structures more and more over time.

Also shown in FIG. 7, the mortgage company calculates estimated savings, as indicated at 155. This may be accomplished by the quantification systems and methods described above, and/or the estimated saving may be made available to the mortgage company. Once the estimated savings have been quantified, the mortgagee will be able to clearly see the benefits and be assured of a return on the investment. Thus, the mortgagee will want to sign the mortgage agreement as indicated at 158. This step forms a contractual agreement in which the mortgagee authorizes the mortgage company to withdraw or otherwise obtain money equal to at least a portion of the estimated savings and apply the money to early payment of the mortgage loan. The portion may be in terms of a percentage, or may be a set amount. Other portions of the savings may be applied to investments, as has been described above, which may also be agreed upon by contract. The mortgagee, or the system on behalf of the mortgagee, may also apply for credits. Alternatively, the system may apply for credits on behalf of the lender or mortgage company in exchange for better terms on the loan. The mortgage will be configured similar to a construction loan in which the mortgage company distributes money in payment to the contractors and for materials, as indicated at 161. The upgrades are made, as indicated at 164.

Once the upgrades have been made, the mortgage loan can be converted to or replaced by a long-term mortgage loan. The data collection system or front end of the utility savings determination and application system is installed, as indicated at 167. Alternatively, the front end may refer to the end having the user interface, and the data collection system may be at the back end. The energy usage data is uploaded periodically and/or continuously, as indicated at 170. The quantification system analyzes the usage data and compares it to the predetermined baseline(s) to quantify the savings, as indicated at 173, as described in the various embodiments herein. Money corresponding to the portion(s) of the energy savings is distributed in accordance with the agreement, as indicated at 176. For example, at least some of the money may be paid to the mortgage company and could simply be shown as a deposit to pay down the principle in the mortgage loan bill sent to the mortgagee. Alternatively or additionally, portion(s) of the savings may be applied to investment in securities, trading carbon credits as a commodity, and/or deposited in a savings account as indicated at 179. Further alternatively, at least a portion could be paid out in cash or deposited in a checking account of the mortgagee.

The value gained corresponds to at least a portion of the energy/utility savings, and whatever units are used to represent that value could be converted into carbon credits. Embodiments of the systems and methods of the present invention enable a mortgagee or mortgagor to actually create a utility company because the system and method enables individuals or companies to deal in carbon credits and become energy producers. Individuals and companies could sell carbon credits to utility and other companies. Also, by using the programs and methods of embodiments of the present invention, individuals and companies can also become providers of energy conservation and energy production systems.

Still further, the utility savings achieved can be utilized to apply for tax credits or other incentive credits such as from the government, as indicated at 182. Other incentives may include tax deductions. These are additional paybacks that could benefit the mortgagee directly, be applied to investments, be applied to early payment of the mortgage loan, and/or be recouped directly by the mortgagor in exchange for improved loan terms. The systems and methods of embodiments of the present invention identify and facilitate application for and receipt of tax incentive credits, which may further reduce cost outlays and closing costs on loans, for example.

Once a mortgage company has adopted the program, the mortgage company may repeat the steps during the life of the mortgage with any given mortgagee, as indicated by the return arrows forming a closed loop 185. Also, the mortgage company may repeat the process with any number of additional mortgages and any number of mortgagees as indicated by the return arrows forming a closed loop 188. One or more of the steps may be omitted or additional steps may be added without limitation. For example, in one embodiment, one or more of the steps of calculating 155, signing 158, distributing loan money 161, and upgrading/building 164 may represent a method 191, which may be separate from a method 194 generally represented by one or more of the steps of installing 167, uploading 170, quantifying 173, and distributing savings 176. That is, the overall method 151 may be separately applied to each of qualifying individuals for green loans, and making a financial transaction based on a utility savings for participants.

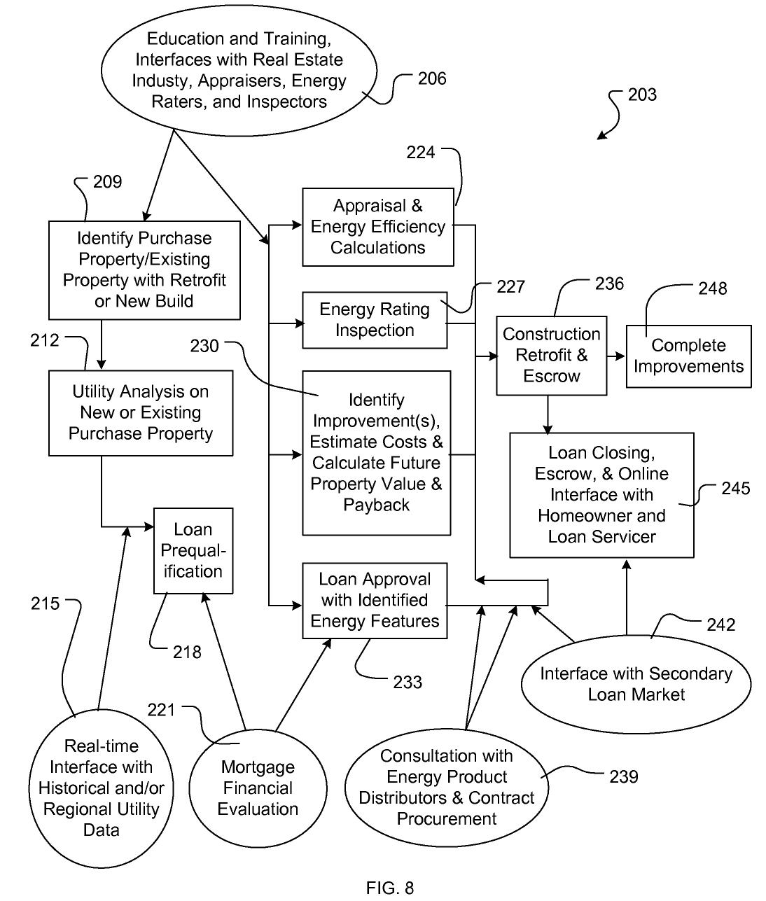

FIG. 8 is a flow diagram showing examples of interacting entities and possible sequences of steps in a new construction or retrofit construction loan process 203. The loan process may begin at an educational or training stage 206. In this education stage 206, appraisers, energy raters, inspectors, users from the real estate industry, and/or other users may receive in-person and/or on-line training regarding the energy quantification system and/or the accelerated community energy system. These and other individuals and companies may be introduced to additional resources that previously were not available or were challenging to access. Even if they could be accessed, doing so required piecing the resources together from multiple sources. Thus, the systems and methods described herein provide a one-stop resource that previously was not available and are excellent marketing tools. For example, users may want to consider the effects of green features or sustainable features in new or retrofit building projects. As such, the user identifies the purchase property or existing property to be supplied with the green and/or sustainable features, as indicated at 209. Once the property has been identified, the utility and energy usage is analyzed 212. At this point, the system may interface in real-time with utility data, or at least with the most current historical and/or utility data, as indicated at 215. The user may be prequalified for a conventional loan 218. This prequalification typically requires an interface with, and evaluation by, a mortgage company or other lender 221. In one embodiment, the prequalification may be based at least in part on a predicted energy savings.

Also shown in FIG. 8, the user may want to alternatively or additionally get an appraisal for the property based on energy efficiency calculations of green and/or sustainable features 224. The calculations indicate the amount of savings over time that can be expected by having the features in the property. That is, the added energy saving and producing features add value, which can be factored in by the appraiser. This may be undertaken at any time. However, the training 206 encourages finding out how the user can save energy, such that getting the appraisal 224 would be a natural next step after the training 206. Another natural sequence would be to get the appraisal 224 after being prequalified 218. Another step for finding out ways to improve energy savings is to get an energy rating inspection 227 by a specialist that is qualified to identify the best ways to reduce energy waste and/or what sustainable features would work best for a particular property. Based on at least one of analyzing historical/utility data 215, performing the energy efficiency analysis and getting the appraisal 224, and the getting the energy rating inspection 227, the process 203 or system identifies improvements 230 that can be made to the new or existing property. In this step 230, costs for the improvements and future property values and paybacks are calculated. These calculations enable approval of a loan 233 having improved terms based on the energy savings, money savings, and/or incentive credits that will be realized with the green and/or sustainable features that have been identified and agreed upon. As with the prequalification 218, a mortgage financial evaluation 221 is performed by a qualified mortgage company or lender.

FIG. 8 also shows that after the stage in which one or more of appraisal 224, inspection 227, improvement identification 230, and loan approval 233 is achieved, the user can move toward actual construction and start of escrow 236 of a new building or retrofit based on the identified energy improvement features. The user may enlist the services of one or more of energy product distributors 239 and/or contractors for installation and construction. In the case of a retrofit construction, the user may interface with a secondary loan market 242 in order to obtain the loan. In any case, the mortgage company or other qualified lender helps to set up escrow and closing for the loan, as indicated at 245. This may be achieved by communication on-line between the property owner and the lender. Finally, the green and/or sustainable energy improvements are completed 248.

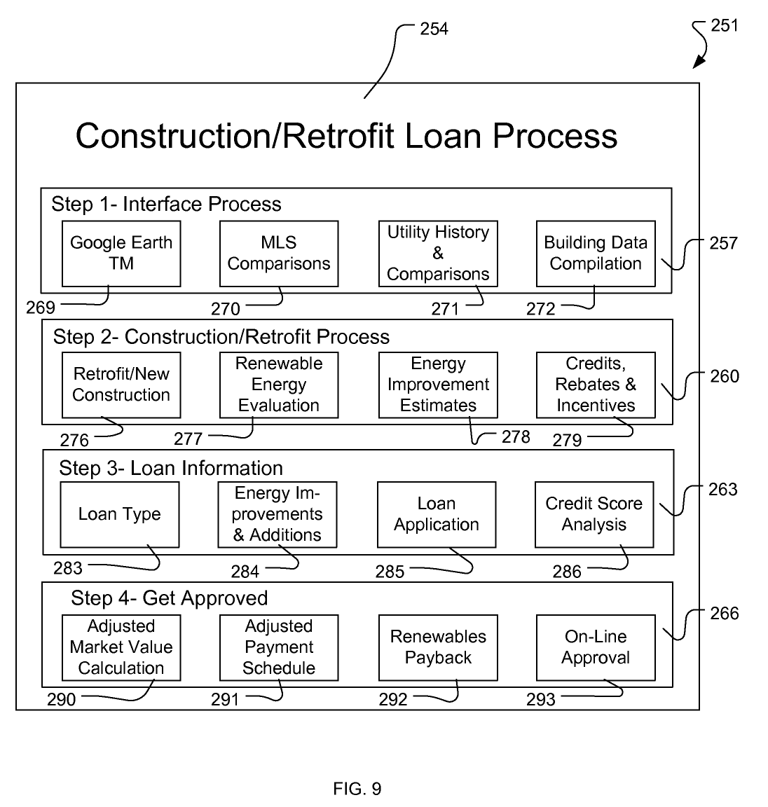

FIG. 9 is an example diagrammatic view depicting a user interface 251 that may be used to present the new construction/retrofit construction loan process with selectable options. The interface 251 may be in the form of a screen display having clickable soft buttons on a computer screen 254, for example. Each of these soft buttons may be associated with a module that performs the functions of the respective soft buttons. The user interface 251 does not necessarily depict all the same elements or flow paths for the loan process as is shown in FIG. 8 even though the user interface 251 is compatible with the process shown in FIG. 8. Rather, the user interface divides the loan process up into four steps including an interface process 257, a construction/retrofit process 260, a loan information step 263, and an approval step 266.

The interface process presents a user with clickable soft buttons including Google Earth™ 269, the MLS 270, and various databases. The interface process 257 shown in FIG. 9 includes a clickable link to utility history and comparisons 271 for utility usage in similar properties and/or constructions and a compilation of building data 272. With the soft buttons of the interface step 257, the user can look at a neighborhood through digital images on Google Earth™, compare pricing and other information through the MLS, and collect and analyze data from utility and building databases. Additionally or alternatively, the interface step may include soft button links to regional climate databases and building construction databases to factor in whether and materials factors on energy savings, for example.

By clicking on the link 272 for compilation of building data, the user may be presented with a questionnaire that prompts the user to answer questions by filling spaces or checking boxes. Alternatively, the soft buttons may include a button for assessing energy usage factors. Upon clicking such a link the user may be presented with a questionnaire including several categories of energy usage factors. One of the categories may be the building shell with fillable cells for: building type (commercial, residential, mixed use); size of building (square feet by floor), construction material (including thickness); number of floors; roof type; number, type, and orientation of doors; number, type, and orientation of windows; garage, building orientation; foundation type, insulation type—wall; insulation type—roof; insulation type—floor; and window sizes/types (R-U value) and orientation. Another category for energy factors may be climate zone with fillable cells for: latitude/longitude; altitude; daily high temperature; daily low temperature; daily average temperature; percent change from previous day; and average daily relative humidity. Another category may be HVAC and appliance with fillable cells for: type of heating system (BTU/kWh/Energy rating); type of cooling system (BTU/kWh/Energy rating); water heater type (BTU/kWh/Energy rating); and major appliances (kWh/Energy rating). Another category may be renewable energy sources with fillable cells for: solar electrical generation (type, output); solar water heating (capacity); wind generator (type, output); and other (type, output, capacity). Another category may be major appliance with fillable cells for: refrigerator (BTU/kWh/Energy rating); stove (BTU/kWh/Energy rating); room air conditioner (BTU/kWh/Energy rating); televisions and computers (kWh/Energy rating); and other (BTU/kWh/Energy rating). Another category may be occupancy information with fillable cells for: number of inhabitants; and age group of the inhabitants (0-5, 6-11, 12-18, 18-25, 25-60, 60+). Another category may be utility information with fillable cells for: identify local utility companies; determine net-metering capability; average daily utility price (electricity/natural gas); and averaged comparables (conventional building energy use). The averaging of comparables may be achieved automatically based on selected comparable properties.

The construction/retrofit process 260 also has clickable links including retrofit/new construction selection link 276, renewable energy evaluation link 277, energy improvement estimates link 278, and credits, rebates, and incentives 279. These links enable a user to select options that best fit the existing property or new building. The system analyzes the options selected to return results. For example, the user may select retrofit in link 276 and particulars for which the system prompts the user in the link 277. Link 278 is used to get estimates of costs for installing improvements. Link 279 may connect to stored information on various credits, rebates, and incentives and the system may have instructions indicating which of the credits, rebates and incentives are available for a particular property in a particular region, state, or country in which they are available.

After a user has elected through the aid of the system and user interface 251 the kind of construction, the system determines all the savings and/or incentive credits that are available and bundles them for further evaluation in the loan information step 263. The systems and methods identify the most affordable, highest performance, and most efficient green and sustainable technologies. Thus, the systems and methods identify good installations options for energy efficiency upgrades, justify those options, and ultimately capture associated capital investment gains. This bundling is region specific since incentives and rebates are specific to cities, counties, states, and countries. Bundling is also dependent on climate and other energy usage factors. Thus, the data is selected based on these and other specifics entered by the user. Based on the calculated information, the system allows the user to select the loan type through clickable link 283. The energy improvements are listed and can be modified such as by adding green or sustainable features through link 284. The user can click the loan application link 285 and fill in the loan application on-line, or at least print out a copy of the application for mailing or hand delivery. As part of the loan application step, or as a separate feature, a link 285 enables the user to run a credit check on-line through link 286.

Once the loan information step 263 has been completed, the user moves to the step of getting the loan approved 266. This step includes several possible sub-steps including calculating the adjusted market value by clicking the link 290. The increased market value achieved through the green and/or sustainable features increases the property value, which in turn enables improved loan terms. This can also translate into higher loan amounts since the property value is increased and payments may be reduced by the improved terms. The user may look at an adjusted payment schedule based on applying saving and/or incentives to early payoff of the loan by clicking link 291. The renewable energy payback link 292 shows savings or credits caused by the green and/or sustainable improvements. Clicking these links may initiate calculations or may pull up graphics and/or text representing calculations and analysis of energy savings and/or production. Once the benefits have been considered, the user may click the link 293 to initiate on-line approval of the loan. Clicking the on-line approval link 293 may present the terms of the loan to the user for approval and lock in. Thus, most if not all of the loan process for green and/or sustainable improvement constructions can be done on-line in a seamless automated system. The information that has been input and the information coming from the analysis is stored in a user and/or property profile for subsequent use and/or update.

The present invention may be embodied in other specific forms without departing from its spirit or essential characteristics. In fact, the embodiments or portions thereof may be combined in any way. The described embodiments are to be considered in all respects only as illustrative and not restrictive. The scope of embodiments of the invention is, therefore, indicated by the appended claims rather than by the foregoing description. All changes which come within the meaning and range of equivalency of the claims are to be embraced within their scope.

What is claimed is:

1. An apparatus for determining an energy savings and applying at least a portion of the savings to a financial transaction, the apparatus comprising:
a metering module configured to receive signals representing usage of one or more of energy, temperature, flow, current, volume, and mass of at least one utility;
an analysis module configured to predetermine a baseline value and compare usage of the at least one utility to the predetermined value and determine a savings of energy; and
an execution module configured to apply at least a portion of the savings to a financial transaction.

2. The apparatus of claim 1, further comprising at least one of the modules configured to convert a plurality of units of usage for the plurality of utilities into a single common energy unit.

3. The apparatus of claim 1, further comprising at least one of the modules configured to convert at least one of the units of usage and energy unit into a single unit of currency.

4. The apparatus of claim 1, wherein the analysis module further comprises a calculation module and at least one of the analysis module and the execution module forms a nexus platform between a sustainable building industry and a financial industry.

5. The apparatus of claim 1, wherein:
the execution module further comprises a bundling module configured to selectively combine a plurality of financial incentives into a package, and
the execution module selectively applies the package to at least one of a retrofit construction or a new building construction that involves at least one of sustainable features and green features.

6. The apparatus of claim 1, wherein the analysis module further comprises a modeling module configured to model financial risk to facilitate capital funding for at least one of a retrofit construction and a new build construction that includes at least one of sustainable features and green features.

7. The apparatus of claim 1, further comprising a tax incentive module configured to identify and apply at least one tax incentive for at least one of a retrofit construction and a new build construction having at least one of sustainable features and green features.

8. The apparatus of claim 1, further comprising an energy usage factors module configured to receive input regarding at least one energy usage factor category from the categories consisting of a building shell, climate zone, HVAC, renewable energy, appliance, building occupancy, and utilities.

9. The apparatus of claim 1, wherein the energy usage factors module comprises a user interface configured to prompt a user for input into a plurality of the usage factor categories.

10. The apparatus of claim 1, further comprising an energy efficient appraisal calculation module configured to add a value of energy savings to an appraised building value.

11. The apparatus of claim 1, further comprising:
a mortgagor module including at least a portion of one of the analysis module and the execution module, the mortgagor module configured for at least one of setting terms of a loan and applying at least a portion of the savings to repayment of the loan; and
a mortgagee module including at least a portion of one of the metering module and the analysis module, the mortgagee module configured for at least one of a collecting and transmitting usage data to the mortgagor and informing the mortgagee of the savings and the portion thereof applied to the repayment of the loan.

12. The apparatus of claim 1, wherein at least one of the mortgagor module and the mortgagee module is integrated in a single application together with at least one of an energy usage factors module and an energy efficient appraisal calculation and wherein the application has a user interface for at least one of inputting data representing energy usage factors and calculating an energy efficient appraisal.

13. A method for determining at least one of an incentive and a savings and applying the at least one of the incentive and the savings to a financial transaction, the method comprising:
automatically determining at least one of an incentive and an energy savings;
automatically applying at least a portion of the at least one of the incentive and the energy savings to a financial transaction.

14. The method of claim 13, wherein determining comprises receiving input through a user interface regarding at least one of a plurality of energy usage factors, and receiving input comprises receiving input under control of machine readable code physically embodied in storage media in a digital processing device.

15. The method of claim 13, further comprising automatically charging a fee to at least one of a financial market and a real estate market for use of the method.

16. The method of claim 13, further comprising automatically determining at least one of an appropriate green feature or a sustainable feature for at least one of a retrofit construction and a new build construction.

17. The method of claim 13, wherein determining comprises selecting a particular regional climate and analyzing a cost and an energy savings for the particular regional climate.

18. The method of claim 13, further comprising absorbing an infrastructure cost by applying the savings to the infrastructure cost.

19. The method of claim 13, wherein determining and applying further comprise accelerating a mortgage loan repayment, by:
determining at least one of a utility savings and a credit incentive; and
applying at least a portion of the at least one of the savings and the credit incentive to a mortgage loan repayment;
wherein determining and applying are implemented automatically according to instructions in machine-readable code.

20. An article of manufacture comprising a computer program storage medium readable by a processor and embodying one or more instructions executable by a processor to perform a method for determining an energy savings and applying at least a portion of the savings or a credit to a financial transaction, the method comprising:
determining at least one of an energy savings and a credit incentive according to the instructions; and
applying at least a portion of at least one of the energy savings and the credit incentive to a financial transaction.

21. The article of manufacture of claim 20, further comprising:
detecting a usage of at least one utility by at least one sensor; and
receiving a signal representing the usage in a processor from the sensor.

22. The article of manufacture of claim 20, wherein applying at least a portion of the savings to a financial transaction comprises applying the portion of the savings automatically according to the machine readable instructions under control of the processor.

23. The article of manufacture of claim 20, wherein applying at least a portion of the at least one of the energy savings and the credit incentive to the financial transaction comprises applying the portion to repayment of a loan.

24. The article of manufacture of claim 23, wherein applying the portion to repayment of the loan comprises:
calculating at least one credit incentive from among renewable energy credits and carbon credits; and
bundling the at least one credit incentive with at least one energy savings.

25. The article of manufacture of claim 24, further comprising offsetting at least one of an interest rate, a closing cost, and a loan balance based on at least one of the credit incentive and the energy savings.
